(19) United States
(12) Patent Application Publication
(10) Pub. No.: US 2025/0365063 A1
(43) Pub. Date: Nov. 27, 2025

(54) RADIO COMMUNICATION SYSTEM, RELAY STATION DEVICE, TERMINAL STATION DEVICE, AND WIRELESS COMMUNICATION METHOD

(71) Applicant: NIPPON TELEGRAPH AND TELEPHONE CORPORATION, Tokyo (JP)

(72) Inventors: Kohei SUZAKI, Musashino-shi (JP); Kenji SUZUKI, Musashino-shi (JP); Yohei KATAYAMA, Musashino-shi (JP); Yosuke FUJINO, Musashino-shi (JP); Kazumitsu SAKAMOTO, Musashino-shi (JP)

(73) Assignee: NIPPON TELEGRAPH AND TELEPHONE CORPORATION, Tokyo (JP)

(21) Appl. No.: 18/873,991

(22) PCT Filed: Jun. 15, 2022
(86) PCT No.: PCT/JP2022/023931

§ 371 Date: Dec. 11, 2024

(51) Int. Cl. H04B 7/155

(52) U.S. Cl. CPC H04B 7/15542

(57) ABSTRACT

An aspect of the present invention includes a mobile collection station device, one or more relay station devices, and one or more terminal station devices, the mobile collection station device is configured to transmit a terminal startup signal for starting up the terminal station device at a second frequency different from a first frequency which is a transmission frequency of the terminal station device, the relay station device is configured to transmit a predetermined signal at the first frequency when the terminal startup signal from the mobile collection station device is received, and the terminal station device is configured to start up the terminal station device and then to transmit a desired data signal to the mobile collection station device when the predetermined signal from the relay station device is received.

### TECHNICAL FIELD

The present invention relates to a technique of a wireless communication system, a relay station device, a terminal station device, and a wireless communication method.

### BACKGROUND ART

For example, there has been progress in the development of remote sensing for collecting data from Internet of Things (IoT) terminals through satellites. In such a satellite sensing platform, in order to realize a battery life of an IoT terminal on the ground, for example, in units of years, it is necessary to uplink data, for example, when it is detected that a low-orbit satellite has arrived in the sky. In order to detect the arrival of a low-orbit satellite in the sky, a means for observing a downlink signal from the satellite to the ground (see, for example, NPL 1) can be considered.

### CITATION LIST

### Non Patent Document

Non Patent Document 1: F. Shu, X. Zhang, T. Kondo, “Development of correlator model for differential VLBI observations of satellites,” 2008 International Conference on Microwave and Millimeter Wave Technology, ICMMT2008 Proceedings, Vol. 1, pp. 443-446, April 2008.

### SUMMARY OF INVENTION

### Technical Problem

However, in the technique disclosed in NPL 1, a circuit that receives a startup signal frequency separately from, for example, the transmission frequency of a low power wide area network (LPWA) is required to be mounted on the terminal side in order to receive a startup signal for starting up a ground-side device from a satellite, which poses a problem of making the terminal expensive. Meanwhile, since there are a plurality of schemes in the LPWA, a ground-side device is required to mount a circuit that receives a startup signal frequency on the terminal side separately from the transmission frequency for each scheme.

In view of the above circumstances, an object of the present invention is to provide a technique that makes it possible to transmit data when a satellite-side device arrives without mounting a circuit that receives the frequency of a startup signal on a ground-side device.

### Solution to Problem

According to an aspect of the present invention, there is provided a wireless communication system including: a mobile collection station device; one or more relay station devices; and one or more terminal station devices, the mobile collection station device is configured to transmit a terminal startup signal for starting up the terminal station device at a second frequency different from a first frequency which is a transmission frequency of the terminal station device, the relay station device is configured to transmit a predetermined signal at the first frequency when the terminal startup signal from the mobile collection station device is received, and the terminal station device is configured to start up the terminal station device and then to transmit a desired data signal to the mobile collection station device when the predetermined signal from the relay station device is received.

According to an aspect of the present invention, there is provided a relay station device including a relay processing unit configured to transmit a predetermined signal to a terminal station device at a first frequency which is a transmission frequency of the terminal station device when a terminal startup signal for making a request for startup of the terminal station device and a request for a mobile collection station device to transmit a desired data signal is received from the mobile collection station device, and a frequency of the terminal startup signal is a second frequency different from the first frequency.

According to an aspect of the present invention, there is provided a terminal station device including a terminal processing unit configured to transmit a desired data signal to a mobile collection station device after starting up the terminal station device when a predetermined signal of a first frequency for starting up the terminal station device based on a terminal startup signal received from the mobile collection station device is received from a relay station device, and a frequency of the terminal startup signal is a second frequency different from the first frequency which is a transmission frequency of the terminal station device.

According to an aspect of the present invention, there is provided a wireless communication method in a wireless communication system including a mobile collection station device, one or more relay station devices, and one or more terminal station devices, the method including: causing the mobile collection station device to transmit a terminal startup signal for starting up the terminal station device at a second frequency different from a first frequency which is a transmission frequency of the terminal station device; causing the relay station device to transmit a predetermined signal at the first frequency when the terminal startup signal from the mobile collection station device is received; and causing the terminal station device to start up the terminal station device and then to transmit a desired data signal to the mobile collection station device when the predetermined signal from the relay station device is received.

### Advantageous Effects of Invention

According to the present invention, it is possible to transmit data when a satellite-side device arrives without mounting a circuit that receives the frequency of a startup signal on a ground-side device.

### BRIEF DESCRIPTION OF DRAWINGS

FIG. 1 is a diagram illustrating a configuration example of a wireless communication system and a configuration example of each device.

FIG. 2 is a diagram illustrating a configuration example and an operation example of the wireless communication system according to a first embodiment.

FIG. 3 is a diagram illustrating an example of a startup signal according to the first embodiment.

FIG. 4 is a flowchart illustrating a processing procedure of a relay station device according to the first embodiment.

FIG. 5 is a flowchart illustrating a processing procedure of a terminal station device according to the first embodiment.

FIG. 6 is a diagram illustrating a modification example of the wireless communication system according to the first embodiment.

FIG. 7 is a diagram illustrating an example of 13 (dBm), 920 (MHz) free space loss and CS level.

FIG. 8 is a diagram illustrating a configuration example and an operation example of a wireless communication system according to a second embodiment.

FIG. 9 is a timing chart of the wireless communication system according to the second embodiment.

FIG. 10 is a flowchart illustrating a processing procedure of a relay station device according to the second embodiment.

FIG. 11 is a diagram illustrating a modification example of the wireless communication system according to the second embodiment.

FIG. 12 is a diagram illustrating an example of a startup signal based on a cyclic code sequence according to a third embodiment.

FIG. 13 is a flowchart illustrating a processing procedure of a terminal station device according to the third embodiment.

FIG. 14 is a diagram illustrating processing of a fourth embodiment.

FIG. 15 is a flowchart illustrating a processing procedure of a terminal station device according to the fourth embodiment.

FIG. 16 is a diagram illustrating an example of an interference signal and processing according to a fifth embodiment.

FIG. 17 is a flowchart illustrating a processing procedure of a relay station device according to the fifth embodiment.

### DESCRIPTION OF EMBODIMENTS

Embodiments of the present invention will be described in detail with reference to the accompanying drawings.

### <Configuration Example of Wireless Communication System and Configuration Example of Each Device>

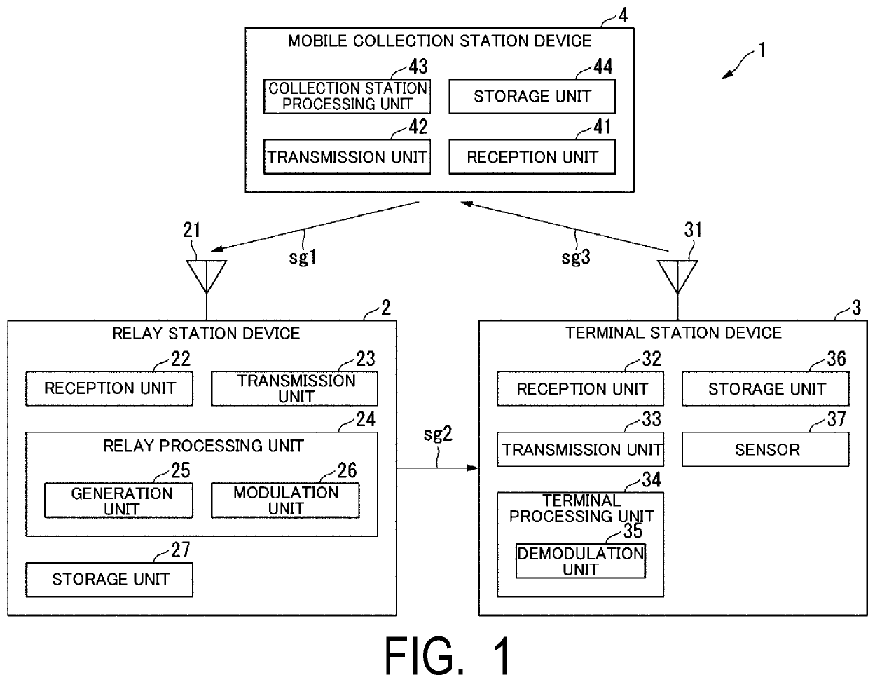

First, a configuration example of a wireless communication system and a configuration example of each device will be described. FIG. 1 is a diagram illustrating a configuration example of a wireless communication system and a configuration example of each device. As shown in FIG. 1, a wireless communication system 1 includes a relay station device 2, a terminal station device 3, and a mobile collection station device 4.

The relay station device 2 includes, for example, an antenna 21, a reception unit 22, a transmission unit 23, a relay processing unit 24, and a storage unit 27. The relay processing unit 24 includes a generation unit 25 and a modulation unit 26.

The terminal station device 3 includes, for example, an antenna 31, a reception unit 32, a transmission unit 33, a terminal processing unit 34, a storage unit 36, and a sensor 37. The terminal processing unit 34 includes a demodulation unit 35.

The mobile collection station device 4 includes, for example, a reception unit 41, a transmission unit 42, a collection station processing unit 43, and a storage unit 44.

### (Mobile Collection Station Device)

The mobile collection station device 4 is, for example, a device included in a low-orbit communication satellite. The mobile collection station device 4 transmits a terminal startup signal sg1 for starting up IoT terminals on the earth. The terminal startup signal sg1 is a signal (downlink) of 400 (MHz) which is a second frequency different from a first frequency that can be received by the terminal station device 3. Meanwhile, the mobile collection station device 4 may be anything that moves such as, for example, a drone, a high altitude platform station (HAPS) which is an unmanned airplane that carries a cellular phone base station device and continues to fly at a high altitude, a train, and a car.

The reception unit 41 receives a transmission signal sg3 (desired data signal) transmitted by the terminal station device 3, and outputs the received transmission signal sg3 to the collection station processing unit 43.

The transmission unit 42 transmits the terminal startup signal output by the collection station processing unit 43.

The collection station processing unit 43 transmits the terminal startup signal sg1 through the transmission unit 42. The collection station processing unit 43 acquires, for example, the transmission signal sg3 received by the reception unit 41, and stores information included in the acquired transmission signal sg3 in the storage unit 44.

The storage unit 44 stores, for example, programs and values used for control by the collection station processing unit 43. The storage unit 44 stores, for example, information based on a transmission signal received from the terminal station device 3.

### (Relay Station Device)

The relay station device 2 receives the terminal startup signal sg1 transmitted by the mobile collection station device 4. The relay station device 2 uses reception of the terminal startup signal sg1 as a trigger to transmit a startup signal sg2 (predetermined signal) obtained by on/off modulating a specific signal sequence to the terminal station device 3. Meanwhile, the number of relay station devices 2 may be two or more. Meanwhile, when the terminal startup signal sg1 for making a request for startup of the terminal station device 3 and a request for the mobile collection station device 4 to transmit a desired data signal is received from the mobile collection station device 4, the relay station device 2 transmits a predetermined signal to the terminal station device 3 at a first frequency which is the transmission frequency of the terminal station device 3. The frequency of the terminal startup signal sg1 is a second frequency different from the first frequency.

The antenna 21 is a transmitting/receiving antenna.

The reception unit 22 receives the terminal startup signal sg1 through the antenna 21, and outputs the received terminal startup signal sg1 to the relay processing unit 24.

The transmission unit 23 transmits the startup signal sg2 output by the relay processing unit 24 to the terminal station device 3 through the antenna 21. Meanwhile, the frequency of the startup signal sg2 (predetermined signal) is a signal of the first frequency that can be received by the terminal station device 3, for example, 920 (MHZ).

The generation unit 25 detects reception of the terminal startup signal sg1 on the basis of information stored in the storage unit 27. The generation unit 25 uses reception of the terminal startup signal sg1 as a trigger to generate a predetermined transmission signal sequence, for example, on the basis of information stored in the storage unit 27.

The modulation unit 26 performs, for example, on/off modulation (0, 1 modulation) on the generated predetermined transmission signal sequence. Meanwhile, the relay station device 2 and the terminal station device 3 store in advance a predetermined transmission signal sequence used as a startup signal and on/off modulation in their own storage unit 27.

The storage unit 27 stores information relating to the predetermined transmission signal sequence. The storage unit 27 stores a modulation method of the predetermined transmission signal sequence. The storage unit 27 stores programs, values, and the like used for control by the relay processing unit 24. The storage unit 27 stores information relating to the terminal startup signal sg1.

### (Terminal Station Device)

The terminal station device 3 receives the startup signal sg2 transmitted by the relay station device 2, demodulates the received signal, and starts up the transmission unit 33. The terminal station device 3 transmits the transmission signal sg3 to the mobile collection station device 4. The terminal station device 3 is, for example, an environmental data collection device that detects and transmits temperature, humidity, and the like. Meanwhile, the number of terminal station devices 3 may be two or more. Meanwhile, the terminal station device 3 does not have a receiving circuit of 400 (MHz) which is the terminal startup signal sg1 transmitted by the mobile collection station device 4.

The antenna 31 is a transmitting/receiving antenna.

The reception unit 32 receives the startup signal sg2 transmitted by the relay station device 2 through the antenna 31, and outputs the received startup signal sg2 to the terminal processing unit 34.

The transmission unit 33 transmits the startup signal sg2 output by the terminal processing unit 34 to the mobile collection station device 4 through the antenna 31. Meanwhile, at least the transmission unit 33 is, for example, in a sleep state in order to save power such as when signals are not being transmitted or received or when detection is being performed by sensors.

The terminal processing unit 34 starts up the transmission unit 33 in a case where it can detect that the startup signal sg2 demodulated by the demodulation unit 35 matches the predetermined signal sequence stored in the storage unit 36.

The demodulation unit 35 has a carrier sense function. Meanwhile, the carrier sense function is, for example, a mechanism for confirming whether another wireless communication station is using the wireless channel (its own channel) through which transmission is attempted to be started before the transmission is started, and avoiding interference by not performing transmission at the same frequency when another wireless communication device is using its own channel. The demodulation unit 35 demodulates the received startup signal sg2 using the carrier sense function.

The storage unit 36 stores information relating to the predetermined signal sequence. The storage unit 36 stores programs, values, and the like used for control by the terminal processing unit 34.

The sensor 37 is, for example, an environmental sensor that detects environmental information such as temperature and humidity.

The relay processing unit 24, the terminal processing unit 34, and the collection station processing unit 43 are each configured using a processor such as a central processing unit (CPU) and a memory. The relay processing unit 24 functions as the generation unit 25 and the modulation unit 26 by a processor executing a program. Meanwhile, all or some of the functions of the relay processing unit 24, the terminal processing unit 34, and the collection station processing unit 43 may be realized using hardware such as an application specific integrated circuit (ASIC), a programmable logic device (PLD), or a field programmable gate array (FPGA). The above program may be recorded on a computer readable recording medium. The computer readable recording medium is, for example, a portable medium such as a flexible disk, a magnetooptic disc, a ROM, a CD-ROM, or a semiconductor storage device (for example, solid state drive (SSD)), or a storage device such as a hard disk built into a computer system or a semiconductor storage device. The above program may be transmitted through an electrical communication line.

### First Embodiment

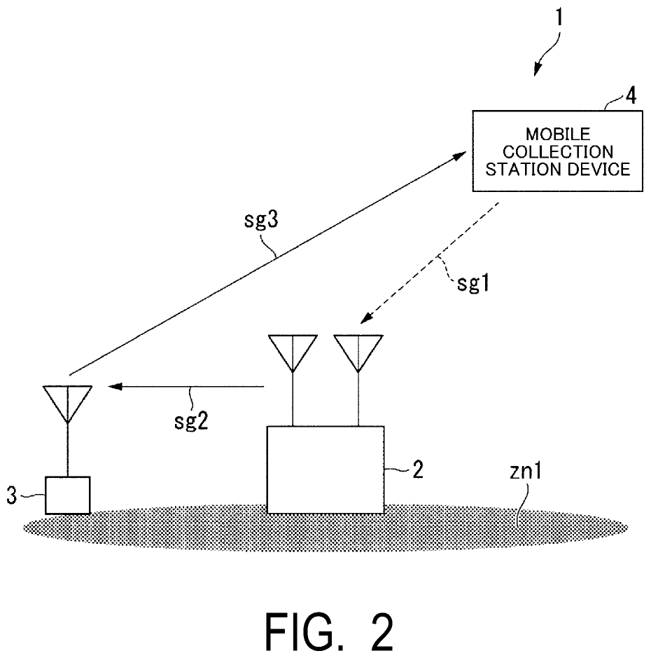

FIG. 2 is a diagram illustrating a configuration example and an operation example of a wireless communication system according to the present embodiment. As shown in FIG. 2, the wireless communication system 1 includes one relay station device 2, one terminal station device 3, and the mobile collection station device 4. Meanwhile, the terminal station device 3 is disposed within a range zn1 in which the startup signal sg2 can be received from the relay station device 2. Each of the relay station device 2, the terminal station device 3, and the mobile collection station device 4 has the configuration described in FIG. 1.

The collection station processing unit 43 transmits the terminal startup signal sg1 through the transmission unit 42. The collection station processing unit 43 acquires, for example, the transmission signal sg3 received by the reception unit 41, and stores information included in the acquired transmission signal sg3 in the storage unit 44.

The relay station device 2 receives the terminal startup signal sg1 transmitted by the mobile collection station device 4. The relay station device 2 uses reception of the terminal startup signal sg1 as a trigger to transmit the startup signal sg2 obtained by on/off modulating a specific signal sequence to the terminal station device 3. Meanwhile, the relay station device 2 continues to transmit the startup signal sg2 to the terminal station device 3 while receiving the terminal startup signal sg1. This implication is because, for example, even if the startup signal sg2 is transmitted once, the terminal station device 3 may not be able to be started up.

The terminal station device 3 receives the startup signal sg2 transmitted by the relay station device 2, demodulates the received signal, and starts up the transmission unit 33. The terminal station device 3 transmits the transmission signal sg3 to the mobile collection station device 4. Meanwhile, the terminal station device 3 may transmit, for example, information indicating that the startup signal sg2 has been received after startup or information indicating that it has been started up to the relay station device 2.

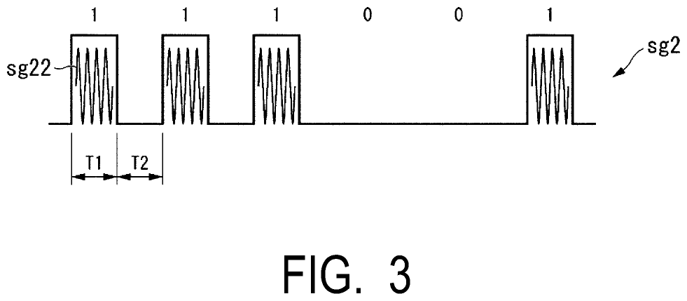

FIG. 3 is a diagram illustrating an example of a startup signal according to the present embodiment. As shown in FIG. 3, the startup signal sg2 is a signal obtained by, for example, on/off modulating a signal sg22 with a frequency of 920 (MHz). The period T1 is an on period, and the period T2 is an off period. In each embodiment, the on state is set to “1” (or “H”) and the off state is set to “0” (or “L”), but reverse logic may be used. Meanwhile, the frequency to be used need only be a transmission frequency used in IoT systems such as, for example, LPWA.

### (Processing Procedure of Relay Station Device)

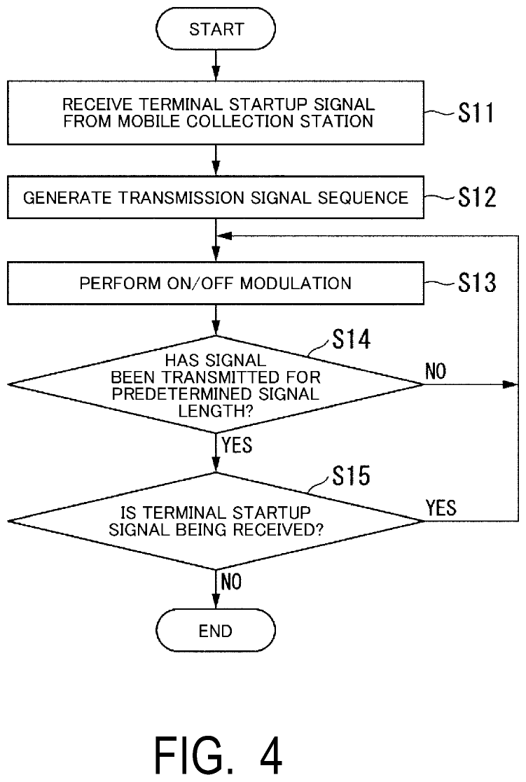

FIG. 4 is a flowchart illustrating a processing procedure of a relay station device according to the present embodiment.

(Step S11) The reception unit 22 receives a terminal startup signal transmitted by the mobile collection station device 4, for example, when the mobile collection station device 4 which is a low-orbit satellite arrives over a data collection area. The generation unit 25 detects that the terminal startup signal has been received on the basis of information stored in the storage unit 27.

(Step S12) The generation unit 25 uses reception of the terminal startup signal as a trigger to generate, for example, a predetermined transmission signal sequence on the basis of the information stored in the storage unit 27.

(Step S13) The modulation unit 26 performs on/off modulation on the generated predetermined transmission signal sequence.

(Step S14) The relay processing unit 24 determines whether the on/off modulated startup signal has been transmitted for a predetermined signal length. In a case where it is determined that the startup signal has been transmitted for the predetermined signal length (step S14; YES), the relay processing unit 24 proceeds to the process of step S15. In a case where it is determined that the startup signal has not been transmitted for the predetermined signal length (step S14; NO), the relay processing unit 24 returns to the process of step S13.

(Step S15) The relay processing unit 24 determines whether the terminal startup signal from the mobile collection station device 4 has been received. In a case where it is determined that the terminal startup signal has been received (step S15; YES), the relay processing unit 24 returns to the process of step S13. Thereby, the relay processing unit 24 repeats transmission of a predetermined signal length while the terminal startup signal is being received. In a case where it is determined that the terminal startup signal has not been received (step S15; NO), the relay processing unit 24 ends the process.

### (Processing Procedure of Terminal Station Device)

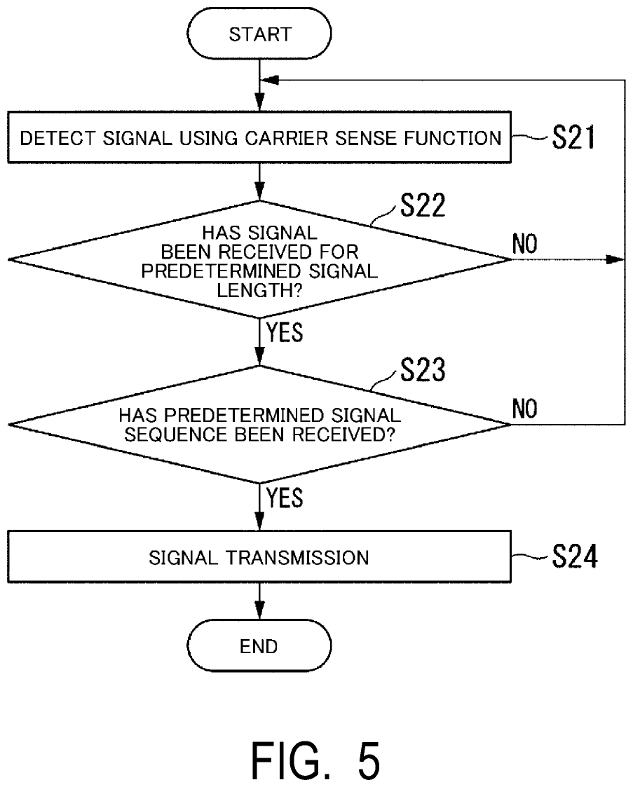

FIG. 5 is a flowchart illustrating a processing procedure of a terminal station device according to the present embodiment.

(Step S21) The demodulation unit 35 demodulates and detects a signal using the carrier sense function.

(Step S22) The terminal processing unit 34 determines whether a signal has been received for the predetermined signal length. In a case where it is determined that a signal has been received for the predetermined signal length (step S22; YES), the terminal processing unit 34 proceeds to the process of step S23. In a case where it is determined that a signal has not been received for the predetermined signal length (step S22; NO), the terminal processing unit 34 returns to the process of step S21.

(Step S23) The terminal processing unit 34 determines whether the received signal is a predetermined signal sequence. In a case where it is determined that the received signal is a predetermined signal sequence (step S23; YES), the terminal processing unit 34 proceeds to the process of step S24. In a case where it is determined that the received signal is not a predetermined signal sequence (step S23; NO), the terminal processing unit 34 returns to the process of step S21.

(Step S24) The terminal processing unit 34 generates a transmission signal and transmits the generated transmission signal to the mobile collection station device 4 through the transmission unit 33 and the antenna 31. After transmission, the terminal processing unit 34 controls, for example, it own unit, the transmission unit 33, and the like to enter a sleep state.

Meanwhile, after startup, the terminal processing unit 34 may end reception of the startup signal transmitted by the relay station device 2. This makes it possible to reduce power consumption required for reception.

Meanwhile, signals used by IoT terminals have various standards such as, for example, a chirp spread spectrum (CSS) signal or a direct sequence spread spectrum (DSSS) signal. For this reason, it is difficult to cope with all communication schemes on the relay station device 2 side.

Therefore, in the present embodiment, the carrier sense function, which is implemented in most IoT terminals, is used to check whether the corresponding frequency ch is being used before its own signal is transmitted. More specifically, the terminal station device 3 encodes the signal as 1 when it exceeds the threshold of the carrier sense function provided in the demodulation unit 35 and as 0 when it falls below the threshold, so that when a specific signal sequence is received, the terminal station device starts up and the mobile collection station device 4 is caused to start transmission.

In the wireless communication system 1 configured in this way, the relay station device 2 does not need to cope with a specific scheme and need only be one type, and the terminal station device 3 can cope with the startup by coping with firmware of the carrier sense function.

### Modification Example

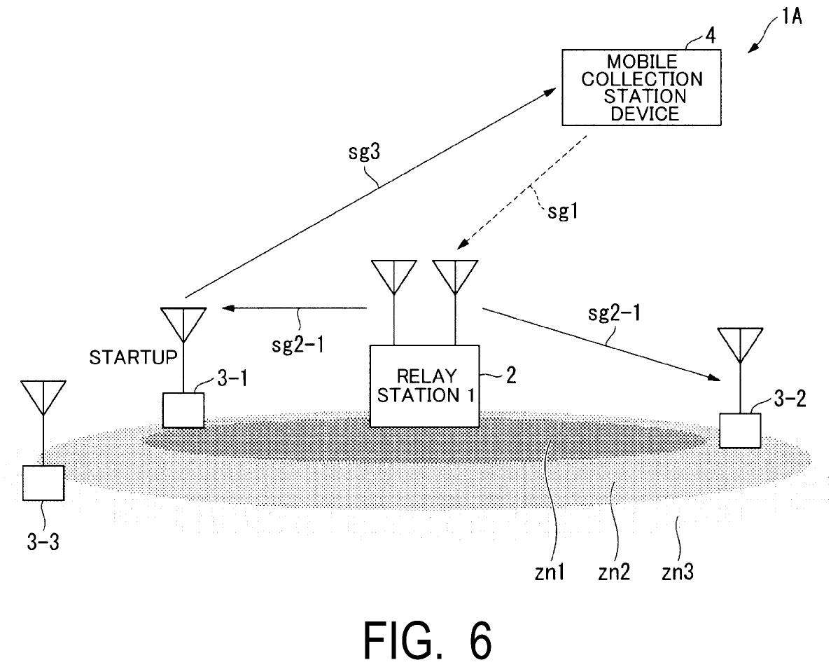

FIG. 6 is a diagram illustrating a modification example of the wireless communication system according to the present embodiment. As shown in FIG. 6, a wireless communication system 1A includes one the relay station device 2, three terminal station devices 3 (3-1, 3-2, 3-3), and the mobile collection station device 4. Meanwhile, the terminal station device 3-1 is disposed within the range zn1. The terminal station device 3-2 is disposed outside the range zn1 and within a range zn2. The terminal station device 3-3 is disposed outside the range zn2 and within a range zn3. Each of the relay station device 2, the terminal station device 3, and the mobile collection station device 4 has the configuration described in FIG. 1.

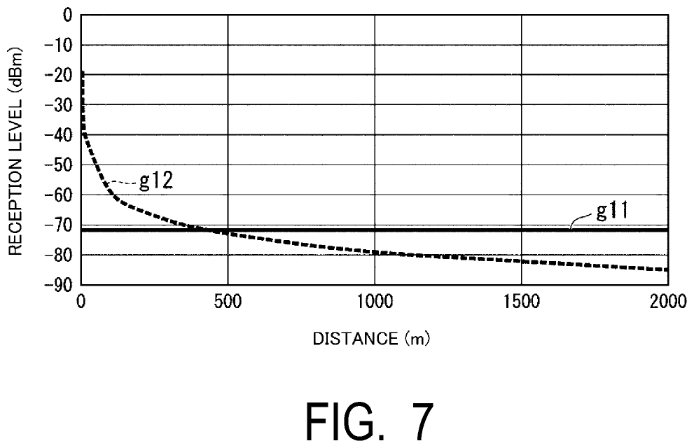

FIG. 7 is a diagram illustrating an example of 13 (dBm), 920 (MHz) free space loss and carrier sense (CS) level. The horizontal axis is distance (m), and the vertical axis is reception level (dBm). A line g11 indicates a carrier sense threshold, and a line g12 indicates a reception level with respect to a distance. As shown in FIG. 7, the threshold of the carrier sense function is uniquely determined by the radio equipment rule or the like. Therefore, the transmission power may be controlled on the relay station device 2 side to control the startup timings of the terminal station devices 3-1, 3-2, 3-3, . . . .

For example, the relay station device 2 may set the transmission power to a large value such as the maximum, start up the terminals accommodated in the area all at once, and then reduce the transmission power. The relay station device 2 may control the transmission at different timings by changing the time during which the transmission is stopped beyond the carrier sense level in this way. On the contrary, the relay station device 2 may adjust the range in which the startup signal reaches and adjust the timing by gradually increasing the power from small power. In the example of FIG. 6, the relay station device 2 starts up the terminal station devices 3-1, 3-2, 3-3, . . . in the order of proximity from the relay station device 2.

This makes it possible to control the startup timings of the terminal station devices 3-1, 3-2, 3-3, . . . .

### Second Embodiment

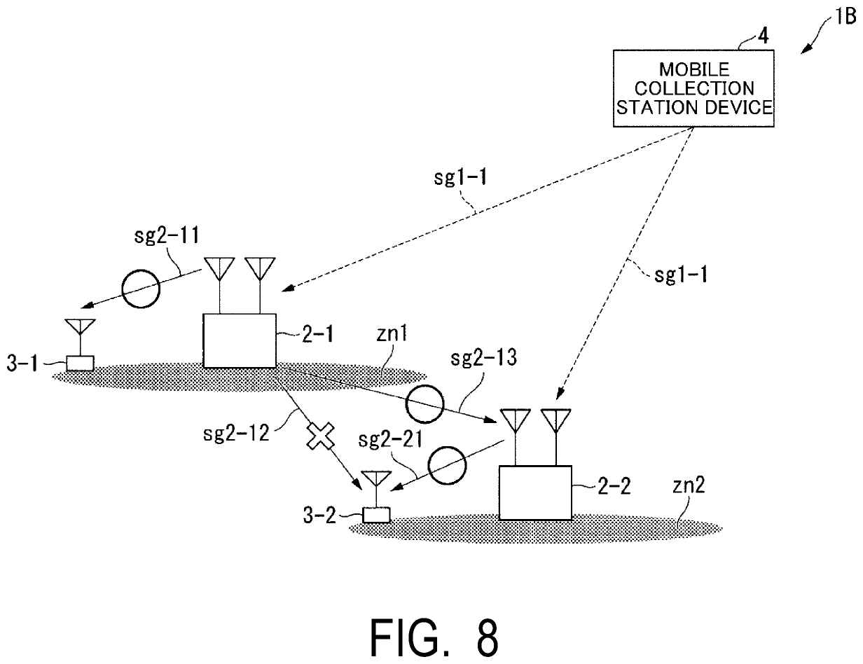

FIG. 8 is a diagram illustrating a configuration example and an operation example of a wireless communication system according to the present embodiment. As shown in FIG. 8, a wireless communication system 1B includes two relay station devices 2 (2-1, 2-2), two terminal station devices 3 (3-1, 3-2), and the mobile collection station device 4. Meanwhile, the terminal station device 3-1 is disposed within the range zn1 in which a startup signal sg2-11 from the relay station device 2-1 can be received. The terminal station device 3-2 is disposed within the range zn2 in which a startup signal sg2-21 from the relay station device 2-2 can be received. In addition, each of the relay station device 2, the terminal station device 3, and the mobile collection station device 4 has the configuration described in FIG. 1.

In the terminal startup signal sg1-1 transmitted from the mobile collection station device 4, a plurality of relay station devices 2 may start up simultaneously and transmit the startup signal simultaneously to peripheral terminals of the relay station device 2. If the frequency channel of the terminal station devices 3 are different from each other, there is no problem, but if the same frequency channel must be used such as because the reception band on the mobile collection station device 4 side is limited, the signals will collide and cause interference, making it impossible to separate them.

In the wireless communication system 1B as shown in FIG. 8, the relay station device 2-1 that has received the terminal startup signal sg1-1 transmits the startup signal sg2-11 to the terminal station device 3-1 located within the communicable range zn1. The relay station device 2-2 that has received the terminal startup signal sg1-2 transmits the startup signal sg2-21 to the terminal station device 3-2 located within the communicable range zn2. If the relay station device 2-1 transmits a startup signal sg2-12 to the terminal station device 3-2 located outside the range zn1, the reception level decreases as the distance increases, so that the CS level becomes, for example, −80 dBm and becomes less than the carrier sense threshold, and the startup signal sg2-21 does not reach the terminal station device 3-2.

In such a case, when the timing at which the terminal station device 3-1 transmits the transmission signal and the timing at which the terminal station device 3-2 transmits the transmission signal overlap each other, interference may occur in the mobile collection station device 4 which is the receiving side.

Therefore, in the present embodiment, unlike the first embodiment, the relay station device 2 performs on/off modulation on the terminal station device 3, and communicates between the relay station devices 2 using, for example, a normal LPWA scheme (for example, a scheme with a low required carrier to noise ratio (C/N) such as a frequency shift keying (FSK) signal or a phase shift keying (PSK) signal). Meanwhile, for example, since the reception sensitivity of a LoRa standard or the like which is a kind of LPWA standard is −130 dBm, a signal between the relay station devices 2 is delivered. Thereby, in the present embodiment, the opposing relay station device 2 demodulates, for example, the LPWA scheme and coordinates the signal transmission timing, so that it is possible to prevent the terminal station device 3-1 and the terminal station device 3-2 from simultaneously outputting signals and causing interference on the mobile collection station device 4 side.

Meanwhile, each relay station device 2 stores, for example, identification information of devices other than its own device in the storage unit 27. For example, the relay station device 2-1 uses reception of the terminal startup signal as a trigger to transmit the startup signal sg2-11 to the terminal station device 3-1 and transmit a signal sg2-13. Meanwhile, the signal sg2-13 may be the startup signal sg2-11.

The relay processing unit 24 of the relay station device 2-2 determines whether the signal sg2-13 transmitted by the relay station device 2-1 has been received before starting to transmit the startup signal g2-21. Meanwhile, the signal sg2-13 transmitted by the relay station device 2-1 includes identification information. In a case where the signal sg2-13 is received, the relay processing unit 24 of the relay station device 2-2 delays the transmission timing of the startup signal to be transmitted to the terminal station device 3-2, for example, for a predetermined time.

### (Example of Transmission/Reception Timing of Wireless Communication System)

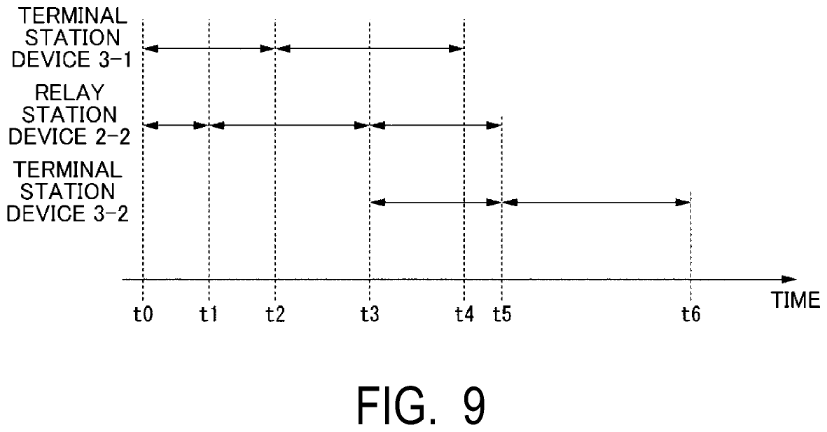

Next, an example of the transmission/reception timing of the wireless communication system 1B will be described. FIG. 9 is a timing chart of the wireless communication system according to the present embodiment. The horizontal axis is time.

The terminal station device 3-1 receives the startup signal from the relay station device 2-1 during a period of times t0 to t2. The terminal station device 3-1 transmits the transmission signal during a period of times t2 to t4.

In addition, the relay station device 2-2 receives the signal sg2-13 from the relay station device 2-1 during a period of times t0 to t1. The relay station device 2-2 waits for transmission of the startup signal to the terminal station device 3-2 during a period of times t1 to t3, and transmits the startup signal to the terminal station device 3-2 during a period of times t3 to t5.

The terminal station device 3-2 receives the startup signal from the relay station device 2-2 during the period of times t3 to t5. The terminal station device 3-2 transmits the transmission signal during a period of times t5 to t6.

This allows the mobile collection station device 4 to receive the transmission signal from the terminal station device 3-1 during the period of times t2 to t4 and to receive the transmission signal from the terminal station device 3-2 during the period of times t5 to t6, making it possible to prevent interference from occurring. Meanwhile, the timing shown in FIG. 9 is an example, and there is no limitation thereto. For example, a period of times t4 to t5 may be approximately 0.

### (Processing Procedure of Relay Station Device)

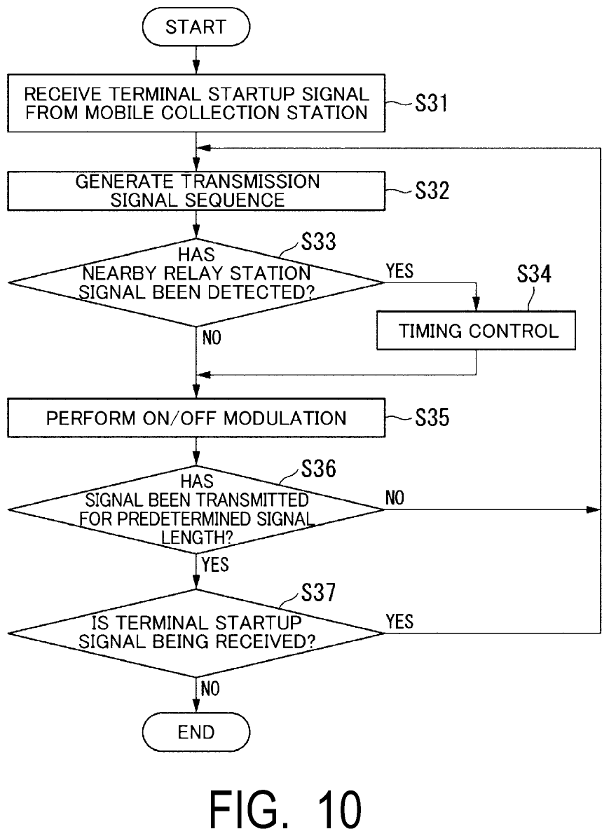

Next, a processing procedure of the relay station device 2-2 will be described. FIG. 10 is a flowchart illustrating of a processing procedure of a relay station device according to the present embodiment.

(Step S31) The reception unit 22 of the relay station device 2-2 receives a terminal startup signal transmitted by the mobile collection station device 4, for example, when the mobile collection station device 4 which is a low-orbit satellite arrives over a data collection area. The generation unit 25 of the relay station device 2-2 detects that the terminal startup signal has been received on the basis of information stored in the storage unit 27.

(Step S32) The generation unit 25 of the relay station device 2-2 uses reception of the terminal startup signal as a trigger to generate, for example, a predetermined transmission signal sequence on the basis of the information stored in the storage unit 27.

(Step S33) The relay processing unit 24 of the relay station device 2-2 determines whether a signal from the nearby relay station device 2 has been detected. In a case where it is determined that a signal from the nearby relay station device 2 has been detected (step S33; YES), the relay processing unit 24 of the relay station device 2-2 proceeds to the process of step S34. In a case where it is determined that a signal from the nearby relay station device 2 has not been detected (step S33; NO), the relay processing unit 24 of the relay station device 2-2 proceeds to the process of step S35.

(Step S34) The relay processing unit 24 of the relay station device 2-2 controls the transmission start timing of the startup signal to be transmitted to the terminal station device 3-2 to be delayed by a predetermined time. After the processing, the relay processing unit 24 of the relay station device 2-2 proceeds to the process of step S35.

(Step S35) The modulation unit 26 of the relay station device 2-2 performs on/off modulation on the generated predetermined transmission signal sequence.

(Step S36) The relay processing unit 24 of the relay station device 2-2 determines whether the on/off modulated startup signal has been transmitted for a predetermined signal length. In a case where it is determined that the startup signal has been transmitted for the predetermined signal length (step S36; YES), the relay processing unit 24 proceeds to the process of step S37. In a case where it is determined that the startup signal has not been transmitted for the predetermined signal length (step S36; NO), the relay processing unit 24 of the relay station device 2-2 returns to the process of step S32.

(Step S37) The relay processing unit 24 of the relay station device 2-2 determines whether the terminal startup signal from the mobile collection station device 4 has been received. In a case where it is determined that the terminal startup signal has been received (step S37; YES), the relay processing unit 24 of the relay station device 2-2 returns to the process of step S32. In a case where it is determined that the terminal startup signal has not been received (step S37; NO), the relay processing unit 24 of the relay station device 2-2 end the process.

Meanwhile, the processing procedures of the terminal station device 3-1 and the terminal station device 3-2 are the same as those in FIG. 5 of the first embodiment. However, as shown in FIG. 9, the terminal station device 3-1 transmits the transmission signal to the mobile collection station device 4, for example, at the timing of time t2. The terminal station device 3-2 then transmits the transmission signal to the mobile collection station device 4, for example, at the timing of time t5 after Δt from time t2 (or the timing of time t5 after Δt′ from time t4).

Meanwhile, FIGS. 8 to 10 illustrate examples in which a signal is transmitted from the relay station device 2-1 to the relay station device 2-2 and the relay station device 2-2 adjusts the timing, but there is no limitation thereto. The relay station device 2 that has received the terminal startup signal beforehand from the mobile collection station device 4 may transmit the signal to the other relay station devices 2. For example, in a case where the relay station device 2-2 receives the terminal startup signal beforehand, the signal may be transmitted from the relay station device 2-2 to the relay station device 2-1, and the relay station device 2-1 may adjust the timing. In this case, the terminal station device 3-2 transmits the transmission signal to the mobile collection station device 4, for example, at the timing of time t2. The terminal station device 3-1 then transmits the transmission signal to the mobile collection station device 4, for example, at the timing of time t5 after Δt from time t2.

In the case of the configuration of the wireless communication system 1B shown in FIG. 8, the terminal station device 3-1 refers only to, for example, power information (envelope) in order to make a confirmation on the basis of the received signal strength indicator. On the other hand, the relay station device 2-2 appears as a signal modulated using any IoT scheme, and can cooperate with the relay station device 2-1 by demodulating the transmission signal from the relay station device 2-1.

Therefore, in the present embodiment, in a case where the relay station device 2-1 and the relay station device 2-2 receive the terminal startup signal from the mobile collection station device 4, these devices wait for a fixed or random time. For example, in a case where the relay station device 2-1 transmits the startup signal beforehand, the relay station device 2-2 demodulates the startup signal transmitted by the relay station device 2-1 and transmits the startup signal to the terminal station device 3-2 so as not to overlap the signal transmission timing of the relay station device 2-1.

In the present embodiment, for example, the terminal station device 3 side receives the startup signal and then determines a rule such as, for example, transmission of a signal in Δt1 seconds or more and less than Δt2 seconds, making it possible to separate the signal in the time axis direction between the terminal station devices 3 located in the communication range of the relay station device 2-1 and the relay station device 2-2.

Here, in the transmission signal at the relay station device 2-1, information such as the next scheduled transmission timing of the terminal station device 3 within the communication range of the relay station device 2-2 or the relay station device 2-1 may be placed on, for example, the startup signal. In the present embodiment, the relay station device 2-2 may be controlled at a timing when it is estimated that the terminal station device 3-1 has completed the transmission after the relay station device 2-1 has transmitted the signal. Alternatively, the relay station device 2-2 may control the transmission timing of the startup signal so that the terminal station device 3-2 transmits the signal at a time that overlaps the transmission time of the relay station device 2-1 (a time when the terminal station device 3-1 is receiving the signal of the relay station device 2-1).

### Modification Example

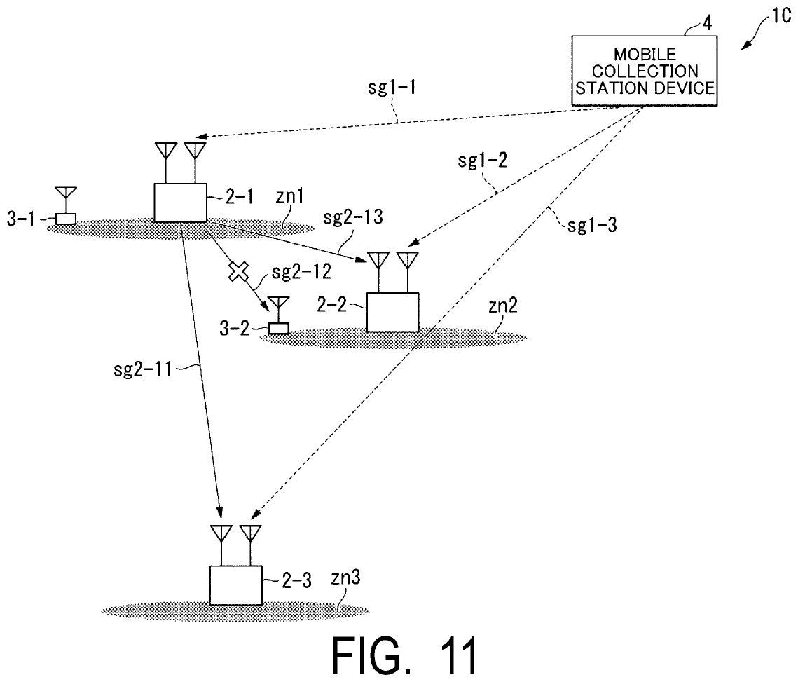

Next, an example in which the number of relay station devices 2 is three will be described. FIG. 11 is a diagram illustrating a modification example of a wireless communication system according to the present embodiment. As shown in FIG. 11, a wireless communication system 1C includes three relay station devices 2 (2-1, 2-2, 2-3), two terminal station devices 3 (3-1, 3-2), and the mobile collection station device 4. Meanwhile, the terminal station device 3-1 is disposed within the range zn1 in which a startup signal sg2-11 from the relay station device 2-1 can be received. The terminal station device 3-2 is disposed within the range zn2 in which a startup signal sg2-21 from the relay station device 2-2 can be received. In addition, each of the relay station device 2, the terminal station device 3, and the mobile collection station device 4 has the configuration described in FIG. 1.

In a case where position information or the like is placed on the transmission signal in the relay station device 2-1 and the relay station device 2-3 determines that the signal can be separated by the angular resolution of the array antenna or the like in the mobile collection station device 4, the terminal station device 3 may be controlled to transmit to the signal at the same time slot as the relay station device 2-1.

As described above, in the present embodiment, the transmission timing of the startup signal is controlled based on determination from the demodulated signal such as time (transmission time or transmission signal length) or space (position information) and information on the angular resolution of the mobile collection station or the like.

Thereby, according to the present embodiment, interference at the mobile collection station of the terminal station can be suppressed.

### Third Embodiment

In the present embodiment, an example in which a cyclic code sequence is used as a predetermined signal sequence will be described.

First, an example of an on/off modulation signal format in carrier sense will be described. Here, a signal sequence where C(x)=G(x)I(x) is used. Meanwhile, it is assumed that G(x) is m-th order generator polynomial and is known in each terminal station device 3.

In the following Math (1), the startup is performed when the remainder becomes 0 by the multiplication of k-th order (k=n−m−1) polynomials I(x) and G(x) such that C(x) is a fixed signal length n.

$$[ Math . 1 ]$$

$$\{ \begin{matrix}G ( x ) = {x}^{m} + {g}_{m - 1} {x}^{m - 1} + … + {g}_{1} x + {g}_{0} \\ I ( x ) = {x}^{k} + {i}_{k - 1} {x}^{k - 1} + … + {i}_{1} x + {i}_{0} \\ C ( x ) = {c}_{n - 1} {x}^{n - 1} + {c}_{n - 2} {x}^{n - 2} + … + {c}_{1} x + {c}_{0}\end{matrix} \qquad ( 1 )$$

Meanwhile, in Math (1), the sign “+” is an exclusive OR. When the coefficients of g, i, and c are 0 or 1, C(x) becomes a cyclic code sequence.

For example, it is assumed that the signal sequence of G(x), I(x), and C(x) is represented by the following Math (2).

$$[ Math . 2 ]$$

$$\{ \begin{matrix}G ( x ) = {x}^{2} + 1 \\ I ( x ) = {x}^{3} + {x}^{2} + 1 \\ C ( x ) = {x}^{5} + {x}^{4} + {x}^{3} + 1\end{matrix} \qquad ( 2 )$$

In this case, C(x) is represented by a cyclic code sequence and becomes.

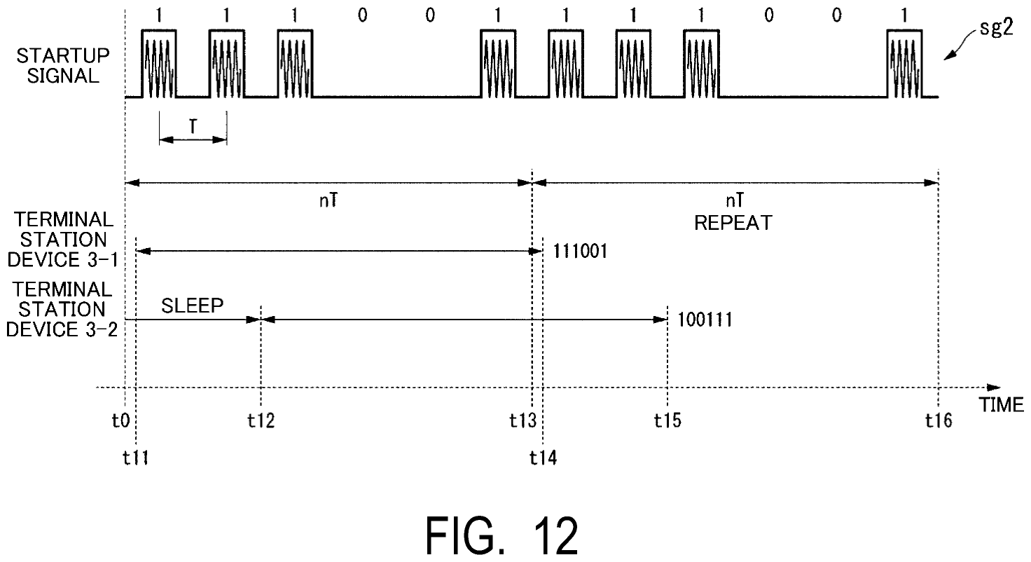

FIG. 12 is a diagram illustrating an example of a startup signal based on a cyclic code sequence according to the present embodiment. In the example of FIG. 12, the startup signal sg2 repeats [111001]. The interval between signals is time T (sampling interval), and one period is nT. For example, times t0 to t13 are the first period, and times t13 to t16 are the second period.

In a case where the terminal station device 3-1 receives such a startup signal sg2 during a period until the fixed signal length n (n=6 in FIG. 11) of the determined sampling interval T is reached, that is, from time t11 to time t14, the terminal station device receives “111001.” On the other hand, in a case where the terminal station device 3-2 is in a sleep state until time t12, starts up at time t12, and receives the signal from time t12 to time t15 after a predetermined time, the terminal station device receives “100111.”

In this case, as shown in FIG. 12, the terminal station device 3-2 is in a sleep state in order to save power when the terminal station device 3-2 performs carrier sense, and thus there is a possibility of the first bit being missed. On the other hand, in the present embodiment, the cyclic code sequence is selected as the startup signal, so that carrier sense is performed only for a fixed length after the terminal station device 3 starts receiving.

Meanwhile, the terminal station device 3 regards that the startup signal has been received in a case where the remainder is 0 by dividing the signal pattern of the received startup signal by, for example, the generator polynomial G(x) of Math (1). Alternatively, the storage unit 36 of each terminal station device 3 may store in advance all the patterns of the cyclic code sequence in the period until the fixed signal length n (n=6 in FIG. 12) of the determined sampling interval T is reached, and compare them with the received signal pattern.

### (Processing Procedure of Terminal Station Device)

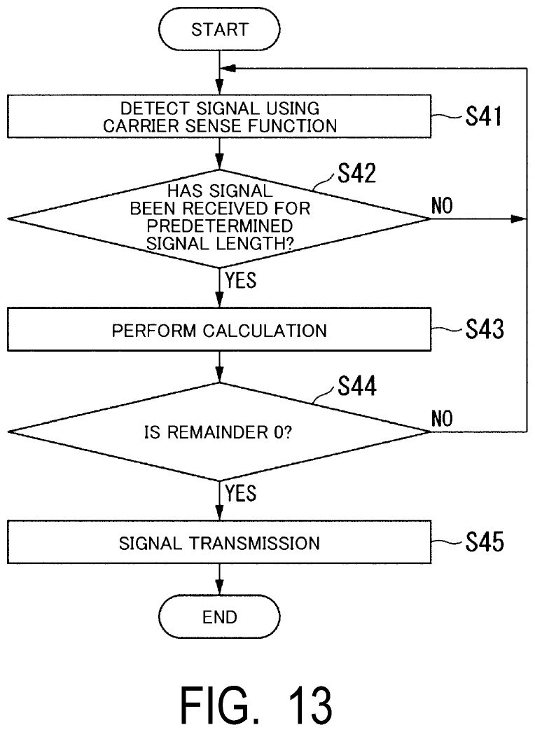

Next, an example of a processing procedure of the terminal station device 3 will be described. Meanwhile, the processing procedure of the relay station device 2 is, for example, the same as the procedure of the first embodiment (FIG. 4), and the relay station device 2 repeatedly transmits a predetermined signal length. FIG. 13 is a flowchart illustrating a processing procedure of a terminal station device according to the present embodiment.

(Step S41) The demodulation unit 35 demodulates and detects a signal using the carrier sense function.

(Step S42) The terminal processing unit 34 determines whether a signal has been received for the predetermined signal length. In a case where it is determined that a signal has been received for the predetermined signal length (step S42; YES), the terminal processing unit 34 proceeds to the process of step S43. In a case where it is determined that a signal has not been received for the predetermined signal length (step S42; NO), the terminal processing unit 34 returns to the process of step S41.

(Step S43) The terminal processing unit 34 divides the received startup signal by, for example, the generator polynomial G(x). After the processing, the terminal processing unit 34 proceeds to the process of step S44.

(Step S44) The terminal processing unit 34 determines whether the remainder is 0 as a result of the division. In a case where it is determined that the remainder is 0 as a result of the division (step S44; YES), the terminal processing unit 34 proceeds to the process of step S45. In a case where it is determined that the remainder is not 0 as a result of the division (step S44; NO), the terminal processing unit 34 returns to the process of step S41.

(Step S45) The terminal processing unit 34 generates a transmission signal and transmits the generated transmission signal to the mobile collection station device 4 through the transmission unit 33 and the antenna 31. After transmission, the terminal processing unit 34 controls, for example, it own unit, the transmission unit 33, and the like to enter a sleep state.

As described above, in the present embodiment, even if the terminal station device cannot receive the first bit, the terminal station device starts up when it receives a signal for a fixed length determined in advance and the calculation result becomes an expected sequence.

Thereby, according to the present embodiment, the timing of the carrier sense function can be relaxed because a specific signal sequence can be determined without receiving it from the first bit of on/off modulation, and power saving based on sleep control can be realized.

### Fourth Embodiment

In the cyclic code sequence transmitted by the relay station device 2, depending on the situation of the interference station, power may exist in space due to signal transmission at a timing intended by the interference station or due to interference even though the code should originally be 0. Therefore, in the present embodiment, bit errors are detected even in a case where bits change due to interference from peripheral stations, and if the number of error bits is equal to or less than a predetermined, it is allowed and startup is performed.

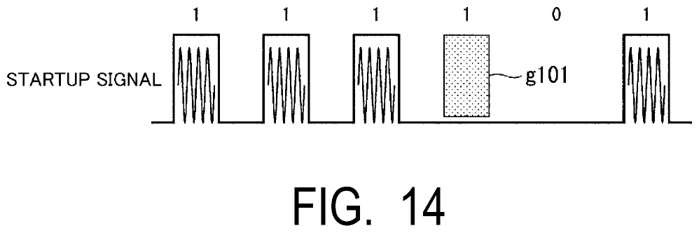

FIG. 14 is a diagram illustrating processing of the present embodiment Meanwhile, FIG. 14 is an example of a startup signal transmitted to the terminal station device 3 by the relay station device 2. The startup signal transmitted to the terminal station device 3 by the relay station device 2 is a cyclic code sequence as in the third embodiment.

Here, as shown in FIG. 12, it is assumed that the terminal station device 3-1 receives the startup signal “111001” and the terminal station device 3-2 receives the startup signal “100111.” In this case, the remainder becomes 0 when the startup signal “111001” received by the terminal station device 3-1 is divided by the generator polynomial G(x), and the remainder becomes 0 when the startup signal “100111” received by the terminal station device 3-2 is divided by the generator polynomial G(x). In a case where the remainder becomes 0 in the fixed length calculation, the terminal station device 3-1 and the terminal station device 3-2 start up and then start to transmit the transmission signal.

However, because of a frequency band in which carrier sense is performed, there is a possibility of a signal being transmitted from the nearby interference station at a time when the relay station device 2 attempts to transmit the signal or when 0 is allocated.

Therefore, for example, in a case where the presence of an interference signal is confirmed beyond an arbitrarily determined threshold in the carrier sense of the relay station device 2-1, the relay station device 2-1 can estimate that interference is also given to the terminal station device 3-1.

In a case where there is no interference, the remainder when the generator polynomial G(x) is set to x²+1 and the original “111001” is divided becomes “000000.”

In a case where interference is detected and then the signal is transmitted as it is, the signal sequence estimated to be received by the terminal station device 3-1 becomes, for example, “111101” as shown in FIG. 14. The reference sign g101 is an example of an interference signal. In this case, when divided by the generator polynomial G(x), the terminal station device 3-1 generates the remainder of “000001.” In this case, a 1-bit error can be detected.

Therefore, in the present embodiment, the terminal station device 3 side detects a bit error, and if the number of error bits is equal to or less than a predetermined number such as, for example, allowing up to a 1-bit error, it is allowed and startup is performed.

### (Processing Procedure of Terminal Station Device)

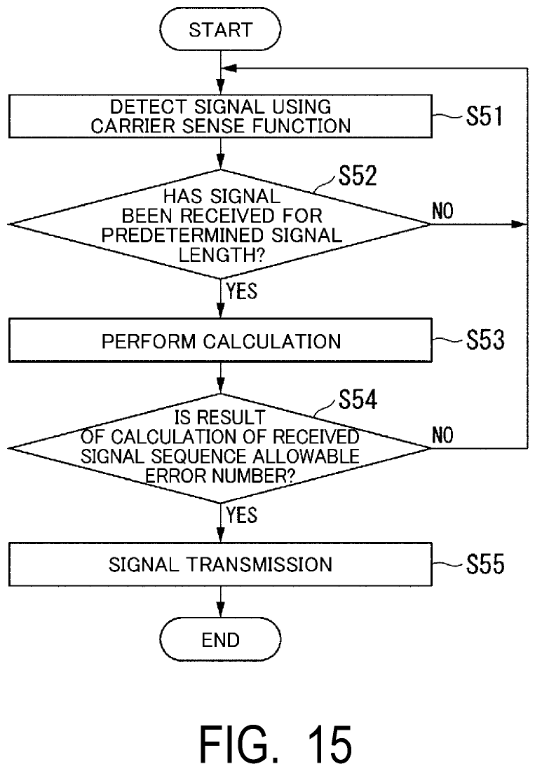

Next, an example of a processing procedure of the terminal station device 3 will be described. Meanwhile, the processing procedure of the relay station device 2 is, for example, the same as the procedure of the first embodiment (FIG. 4), and the relay station device 2 repeatedly transmits a predetermined signal length. FIG. 15 is a flowchart illustrating a processing procedure of a terminal station device according to the present embodiment.

(Step S51) The demodulation unit 35 demodulates and detects a signal using the carrier sense function.

(Step S52) The terminal processing unit 34 determines whether a signal has been received for the predetermined signal length. In a case where it is determined that a signal has been received for the predetermined signal length (step S52; YES), the terminal processing unit 34 proceeds to the process of step S53. In a case where it is determined that a signal has not been received for the predetermined signal length (step S52; NO), the terminal processing unit 34 returns to the process of step S51.

(Step S53) The terminal processing unit 34 divides the received startup signal by, for example, the generator polynomial G(x). After the processing, the terminal processing unit 34 proceeds to the process of step S54.

(Step S54) The terminal processing unit 34 determines whether the result of the division is an allowable error number. In a case where it is determined that the result of the division is an allowable error number (step S54; YES), the terminal processing unit 34 proceeds to the process of step S45. In a case where it is determined that the result of the division is not an allowable error number (step S54; NO), the terminal processing unit 34 returns to the process of step S51.

(Step S55) The terminal processing unit 34 generates a transmission signal and transmits the generated transmission signal to the mobile collection station device 4 through the transmission unit 33 and the antenna 31. After transmission, the terminal processing unit 34 controls, for example, it own unit, the transmission unit 33, and the like to enter a sleep state.

As described above, in the present embodiment, bit errors are detected, and if the number of error bits is equal to or less than a predetermined number, it is allowed and startup is performed.

Thereby, according to the present embodiment, it is possible to improve anti-interference.

### Fifth Embodiment

As described in the fourth embodiment, interference may occur with the startup signal. For example, depending on the situation of the interference station, power may exist in space due to signal transmission at a timing intended by its own device or due to interference even though the code should originally be 0. Therefore, in the present embodiment, in a case where the relay station device 2 detects interference, the terminal station device 3 side changes the transmission signal sequence so that an expected calculation result is obtained.

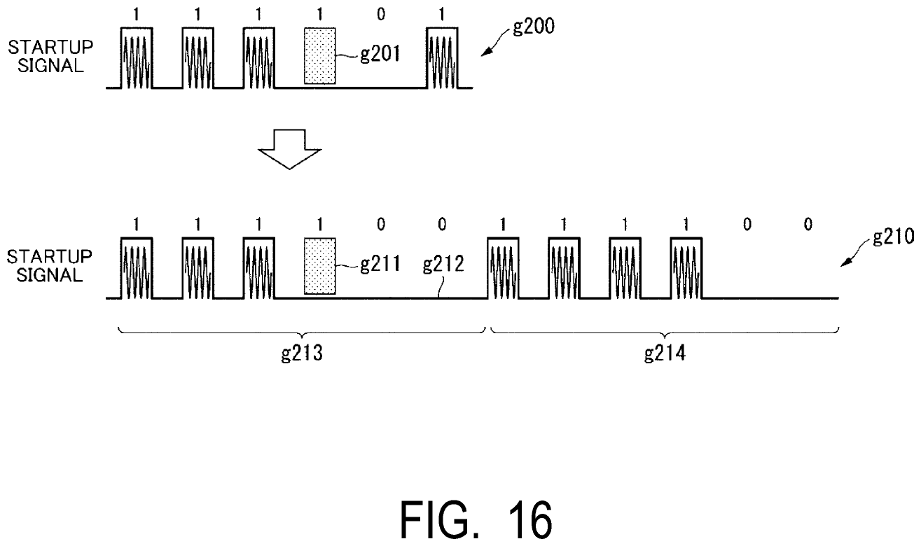

FIG. 16 is a diagram illustrating an example of an interference signal and processing according to the present embodiment.

A reference sign g200 is an example of an startup signal including an interference signal of a reference sign g201. A reference sign g210 is a diagram illustrating processing of the present embodiment.

In the present embodiment, the relay station device 2 adds the remaining bits for which interference (reference sign g211) is estimated to the signal sequence (reference sign g213) of the first round of transmission, for example, using exclusive OR, and changes the last bit from 1 to 0 (reference sign g212). Further, in the present embodiment, in the signal (reference sign g214) of the second round, transmission is started using a new cyclic code sequence by transmitting a time slot in which interference is detected by itself.

Meanwhile, in the present embodiment, the startup signal transmitted by the relay station device 2 may be a cyclic code sequence, or may not be a cyclic code sequence.

### (Processing Procedure of Relay Station Device)

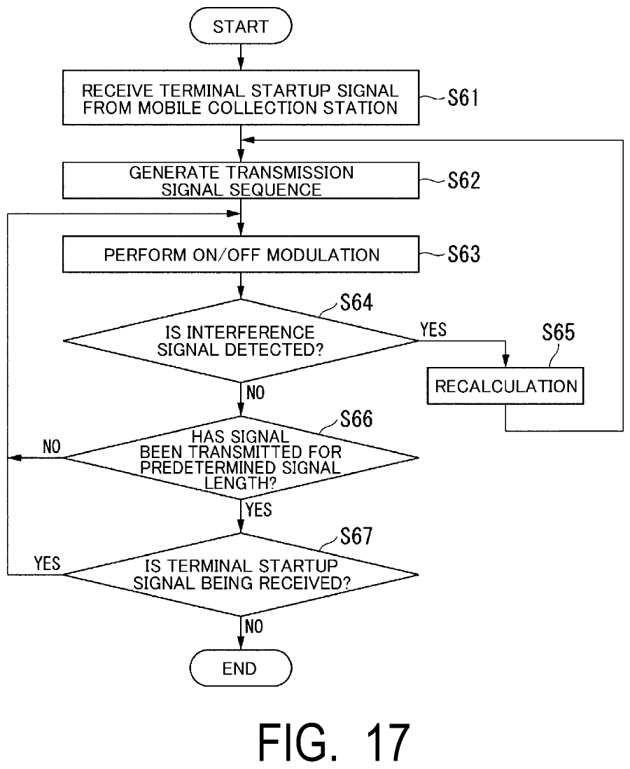

Next, a processing procedure of the relay station device 2 will be described. FIG. 17 is a flowchart illustrating a processing procedure of a relay station device according to the present embodiment.

(Step S61) The reception unit 22 receives a terminal startup signal transmitted by the mobile collection station device 4, for example, when the mobile collection station device 4 which is a low-orbit satellite arrives over a data collection area. The generation unit 25 detects that the terminal startup signal has been received on the basis of information stored in the storage unit 27.

(Step S62) The generation unit 25 uses reception of the terminal startup signal as a trigger to generate, for example, a predetermined transmission signal sequence on the basis of the information stored in the storage unit 27.

(Step S63) The modulation unit 26 performs on/off modulation on the generated predetermined transmission signal sequence.

(Step S64) The relay processing unit 24 determines whether an interference signal has been detected. In a case where it is determined that an interference signal has been detected (step S64; YES), the relay processing unit 24 proceeds to the process of step S65. In a case where it is determined that an interference signal has not been detected (step S64; NO), the relay processing unit 24 proceeds to the process of step S66.

(Step S65) The relay processing unit 24 recalculates the startup signal to generate a new cyclic code sequence. After processing, the relay processing unit 24 returns to the process of step S62.

(Step S66) The relay processing unit 24 determines whether the on/off modulated startup signal has been transmitted for a predetermined signal length. In a case where it is determined that the startup signal has been transmitted for the predetermined signal length (step S66; YES), the relay processing unit 24 proceeds to the process of step S67. In a case where it is determined that the startup signal has not been transmitted for the predetermined signal length (step S66; NO), the relay processing unit 24 returns to the process of step S63.

(Step S67) The relay processing unit 24 determines whether the terminal startup signal from the mobile collection station device 4 has been received. In a case where it is determined that the terminal startup signal has been received (step S67; YES), the relay processing unit 24 returns to the process of step S63. In a case where it is determined that the terminal startup signal has not been received (step S67; NO), the relay processing unit 24 ends the process.

As described above, in the present embodiment, in a case where the relay station device 2 detects interference, the terminal station device 3 side changes the transmission signal sequence so that an expected calculation result is obtained.

Thereby, according to the present embodiment, it is possible to improve anti-interference.

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention is applicable to wireless communication systems including IoT devices and mobile collection station devices that move.

### REFERENCE SIGNS LIST

1, 1A, 1B, 1C Wireless communication system, 2, 2-1, 2-2, 2-3 Relay station device, 3, 3-1, 3-2, 3-3 Terminal station device, 4 Mobile collection station device, 21 Antenna, 22 Reception unit, 23 Transmission unit, 24 Relay processing unit, 25 Generation unit, 26 Modulation unit, 27 Storage unit, 31 Antenna, 32 Reception unit, 33 Transmission unit, 34 Terminal processing unit, 35 Demodulation unit, 36 Storage unit, 37 Sensor, 41 Reception unit, 42 Transmission unit, 43 Collection station processing unit, 44 Storage unit

1. A wireless communication system comprising:
a mobile collection station device;
one or more relay station devices; and
one or more terminal station devices,
wherein the mobile collection station device is configured to transmit a terminal startup signal for starting up the terminal station device at a second frequency different from a first frequency which is a transmission frequency of the terminal station device,
the relay station device is configured to transmit a predetermined signal at the first frequency when the terminal startup signal from the mobile collection station device is received, and
the terminal station device is configured to start up the terminal station device and then to transmit a desired data signal to the mobile collection station device when the predetermined signal from the relay station device is received.

2. The communication system according to claim 1, wherein
the relay station device comprises a first relay station device and a second relay station device,
the terminal station device comprises a first terminal station device and a second terminal station device,
the first relay station device transmits the predetermined signal to the first terminal station device using a signal of a modulation scheme with a low required carrier to noise ratio (C/N), and notifies the nearby second relay station device of a transmission timing, and
the first relay station device and the second relay station device control a timing at which the first terminal station device and the second terminal station device transmit the desired data signal by shifting a transmission timing of the terminal startup signal which is transmitted to the second terminal station device by the second relay station device.

3. The communication system according to claim 1, wherein the relay station device uses a cyclic code sequence for the predetermined signal to perform control so that the terminal station device is able to start up even in a case where a start timing at which the predetermined signal is detected is shifted.

4. The communication system according to claim 3, wherein the terminal station device detects the number of error bits for the received predetermined signal, and starts up the terminal station device when the number of error bits is equal to or less than a predetermined number.

5. The wireless communication system according to claim 1, wherein in a case where interference is detected in the predetermined signal, the relay station device changes a transmission pattern for the predetermined signal and controls the terminal station device serving as a reception side to obtain the same result.

6. A relay station device comprising a relay processing unit configured to transmit a predetermined signal to a terminal station device at a first frequency which is a transmission frequency of the terminal station device when a terminal startup signal for making a request for startup of the terminal station device and a request for a mobile collection station device to transmit a desired data signal is received from the mobile collection station device,
wherein a frequency of the terminal startup signal is a second frequency different from the first frequency.

7. A terminal station device comprising a terminal processing unit configured to transmit a desired data signal to a mobile collection station device after starting up the terminal station device when a predetermined signal of a first frequency for starting up the terminal station device based on a terminal startup signal received from the mobile collection station device is received from a relay station device,
wherein a frequency of the terminal startup signal is a second frequency different from the first frequency which is a transmission frequency of the terminal station device.

8. A wireless communication method in a wireless communication system comprising a mobile collection station device, one or more relay station devices, and one or more terminal station devices, the method comprising:
causing the mobile collection station device to transmit a terminal startup signal for starting up the terminal station device at a second frequency different from a first frequency which is a transmission frequency of the terminal station device;
causing the relay station device to transmit a predetermined signal at the first frequency when the terminal startup signal from the mobile collection station device is received; and
causing the terminal station device to start up the terminal station device and then to transmit a desired data signal to the mobile collection station device when the predetermined signal from the relay station device is received.
